(19) United States
(12) Patent Application Publication
(10) Pub. No.: US 2025/0233234 A1
(43) Pub. Date: Jul. 17, 2025

(54) ENERGY STORAGE DEVICE FOR A MOTOR VEHICLE AND MOTOR VEHICLE COMPRISING AN ELECTRIC MACHINE AND AN ENERGY STORAGE DEVICE CONNECTED TO THE ELECTRIC MACHINE

(71) Applicant: AUDI AG, Ingolstadt (DE)

(72) Inventors: Uwe GERLINGER, Kipfenberg (DE); Carsten LORENZ, Reichertshofen (DE); Eduard MAIN, Buxheim (DE)

(73) Assignee: AUDI AG, Ingolstadt (DE)

(21) Appl. No.: 18/978,256

(22) Filed: Dec. 12, 2024

(30) Foreign Application Priority Data
Jan. 12, 2024 (DE) 102024100951.9

(51) Int. Cl. H01M 10/6557; H01M 10/613; H01M 10/625; H01M 10/647; H01M 50/242; H01M 50/249

(52) U.S. Cl. CPC H01M 10/6557; H01M 10/613; H01M 10/625; H01M 10/647; H01M 50/242; H01M 50/249

(57) ABSTRACT

An energy storage device for a motor vehicle, including an energy storage housing and at least one battery cell accommodated therein. At least one cooling device is arranged adjacent to the battery cell or to at least one of the battery cells in such a way that this battery cell can be cooled by a cooling fluid guided in at least one cooling fluid guide portion of the cooling device. At least one portion of the cooling device is plastically or elastically deformable, so that an expansion of the adjacent battery cell or the adjacent battery cells due to the charging cycle and/or aging causes a deformation of the cooling device in such a way that the cross-section of the cooling fluid guide portion is reduced at least in portions.

### FIELD

The present invention relates to an energy storage device for a motor vehicle, comprising an energy storage housing and at least one battery cell accommodated therein, wherein at least one cooling device is arranged adjacent to the battery cell or to at least one of the battery cells in such a way that this battery cell can be cooled by means of a cooling fluid guided in at least one cooling fluid guide portion of the cooling device.

### BACKGROUND

Motor vehicles with an electric drive, so-called electric vehicles, are becoming increasingly important. In electric vehicles, traction torque is generated by an electric machine or an electric motor. If the traction torque is generated exclusively by means of the electric machine, it is referred to as a purely electric vehicle. If the traction torque is also generated by means of an internal combustion engine, it is called a hybrid vehicle.

In connection with electric vehicles, a number of technological challenges arise, in particular with regard to the storage of electrical energy on the vehicle side, which is necessary in this context. For this purpose, electric vehicles have a rechargeable, electrical energy storage device, which is often referred to as an accumulator. The energy storage device has at least one battery cell with an electrochemically active material. The energy storage device is connected to the electric machine so that energy is made available to generate the traction torque. Energy storage devices with the largest possible storage capacity are desirable in order to achieve a long range of the motor vehicle.

A problem associated with energy storage devices or their battery cells is the fact that they heat up during operation, particularly during charging or when transferring energy to the electric machine. However, the temperature of the battery cells should not exceed certain limits in order to ensure the longest possible service life. In the worst case, the energy storage device could catch fire or be damaged if it becomes too hot, which could lead to the release of substances that are harmful to health and/or the environment. It is therefore of great importance to cool energy storage devices or battery cells in motor vehicles, wherein in addition to indirect cooling, which is achieved, for example, by means of airflow, direct cooling is often provided. With direct cooling, a cooling fluid is actively pumped to the battery cells for cooling.

From the prior art, cooling concepts are known for realizing such cooling, in which cooling bodies through which a cooling fluid can flow are provided, which are arranged next to or between the battery cells. Such concepts, in which porous metal foams are used as a material for the cooling body, are known from DE 10 2018 131 951 A1, WO 2020/223 747 A1 and DE 10 2009 001 592 A1.

Another problem with electrical energy storage is that the volume of the battery cells does not always remain constant over their lifetime. Such an increase in volume, also called “swelling,” can occur during charging and discharging. An age-related increase in volume of the battery cell often occurs. Such volume increases or expansions must be taken into account with regard to the installation space.

### SUMMARY

The object of the invention is to provide an improved concept in connection with an energy storage device of a motor vehicle, in particular with regard to cooling and the problem of swelling.

According to the invention, the object is achieved in an energy storage device of the type mentioned at the outset in that at least one portion of the cooling device is plastically or elastically deformable, so that an expansion of the adjacent battery cell or adjacent battery cells due to the charging cycle and/or aging causes a deformation of the cooling device such that the cross-section of the cooling fluid guide portion is reduced at least in portions.

The present invention provides a common and synergistic means of solving both of the problems mentioned. Thus, in the cooling fluid guide portion, which in particular forms a cooling channel, the cooling fluid for cooling the battery cell is provided on the one hand. On the other hand, the cooling fluid guide portion serves as a compensating volume, which enables volume compensation in the event of an expansion-related, particularly lateral, volume increase of the battery cell. The cooling fluid can be a cooling liquid, such as water and/or glycol.

The occurrence of swelling causes an expansion or enlargement of the volume of the battery cell and an increasing space requirement for the same. In the energy storage device according to the invention, this increasing space requirement is compensated or balanced, in particular completely, by reducing the cross-section of the cooling fluid guide portion. Thus, the increase in volume of the battery cell leads to at least a local deformation of the cooling device, so that a narrowing or tapering occurs in the corresponding region of the cooling fluid guide portion. In summary, the expansion of the battery cell causes a reduction in the size of the cooling fluid guide portion, which partially or completely compensates for this enlargement.

It is conceivable that the plastic or elastic deformation of the cooling device occurs because no alternative volume is available for the battery cell. For this purpose, the at least one battery cell and the cooling device are preferably arranged without play in a receiving space provided in the interior of the energy storage housing. It is also conceivable that the energy storage housing has a higher mechanical strength than the plastically or elastically deformable portion of the cooling device, so that the expanding battery cell causes approximately exclusively a corresponding deformation of the cooling device, but not of the energy storage housing.

The functionality of the cooling fluid guide portion with regard to the guidance of the cooling fluid is not fundamentally impaired by the reduction in size of the same. Thus, the volume flow of the cooling fluid required to achieve a sufficiently high cooling performance can in principle also be generated in the case of a cross-sectional reduction of the cooling fluid guide portion, namely by means of at least a local increase in the flow velocity. For this purpose, a coolant pump with sufficient power must be provided. Furthermore, in order to maintain the cooling effect, it is necessary that the structural integrity of the cooling device and in particular of the cooling fluid guide portion, in particular with regard to fluid tightness, is maintained. This is achieved by the expansion of the battery cell causing the plastic or elastic deformation of the cooling device. This means that the material of the cooling device, at least in the region affected by the deformation, is sufficiently elastic, flexible or tough so that a deformation occurring as part of a typically occurring expansion of the battery cell does not lead to a material breakage.

The battery cell may comprise a battery cell housing into which an active material unit is inserted. The active material unit forms the electrochemically active part of the battery cell for generating a voltage difference. The active material unit is in particular layered and can form a lithium-ion accumulator or another type of battery. The active material unit is the part of the battery cell that causes swelling. The battery cell can also comprise exclusively the active material unit, so that in particular no battery cell housing is provided, so that the active material unit is arranged immediately adjacent to the cooling device. If the battery cell housing is provided, it is mechanically formed and in particular sufficiently flexible such that the occurrence of swelling in the active material unit is not or only slightly inhibited by it.

Particularly preferably, the battery cell or at least one of the battery cells and the cooling device or at least one of the cooling devices are plate-shaped. The term “plate-shaped” means that the extent of the respective component with respect to a plane is substantially larger, in particular more than ten times larger, than its extent perpendicular to this plane. Thus, the plate-shaped component has two large outer surfaces that lie opposite one another and essentially form the plate surfaces, which are significantly larger than the other, lateral outer surfaces of this component. In the at least one pair comprising the cooling device or one of the cooling devices and the battery cell arranged adjacent thereto, the respective plate surfaces are arranged directly adjacent to one another and are preferably in touching contact with one another. This ensures the most effective heat transfer possible.

The battery cell or at least one of the battery cells and the cooling device can be rectangular or cuboid-shaped. This means that the outer surfaces have a rectangular shape. In general, the large outer surfaces can have a polygonal shape. The at least one battery cell and the cooling device or their large-area outer surfaces can in particular be hexagonal.

Particularly preferably, a plurality of battery cells are provided, wherein the cooling device or at least one of the cooling devices is arranged between at least two of the battery cells. The battery cells can form a cell stack into which the at least one cooling device is integrated. Thus, one of the battery cells can be arranged on opposite sides of the at least one cooling device. Preferably, the battery cells and the cooling device or cooling devices are arranged next to one another, in particular alternately, in series.

If the battery cell or at least one of the battery cells and the cooling device are rectangular or cuboid-shaped, then the resulting cell stack also has the shape of a cuboid. If the hexagonal shape is intended in this regard, then the resulting cell stack has the shape of a prism with a hexagonal base. The receiving space of the energy storage housing and the cell stack preferably have the same dimensions or are identical in terms of their geometric shape.

Preferably, at least one holding element is arranged at least in portions between the battery cells between which the cooling device is arranged, wherein the holding element or at least one of the holding elements defines the distance between the respective battery cells and holds the cooling device. The holding element performs several functions, namely, on the one hand, the holding and fastening of the respective cooling device and, on the other hand, the definition and maintenance of a required distance between the two adjacent battery cells between which the respective cooling device is arranged. The holding element forms a mechanical link between the cooling device and the adjacent battery cells. The holding element can also be fastened to the energy storage housing. Clamping, welding or screw connections or the like can be provided for fastening the cooling device and/or the battery cells to the holding element and/or the holding element to the energy storage housing.

Viewed in cross-section, the holding element can be one-piece or multi-part in particular in two parts. In the case of the multi-part holding element, the holding element can comprise a first component and a second component. To fasten the cooling device to the holding element, it can be brought together with the first component. This means that the cooling device is placed in a correspondingly designated position on the first component. Subsequently, a second component of the holding element can be connected to the first component, for example by means of a clip connection, to form a connection between the holding element and the cooling device.

It is conceivable that the holding element or at least one of the holding elements is a holding frame that laterally surrounds the cooling device. According to this embodiment, the cooling device, in particular the large-area outer surface, has a central region, in particular a flat one, and an outer region laterally bordering the central region, wherein the holding frame is arranged or fastened to the outer region or to the lateral outer surfaces. The flange, if present, extends in particular along the outer region or along the lateral outer surfaces. According to this embodiment, a large part of the transfer of heat from the respective battery cell to the cooling device takes place in the central region, while the outer region mainly serves to connect to the holding frame. The geometric shape of the holding frame and the geometric shape of the cooling device or the external region are adapted to each other and in particular correspond to each other. The holding frame can have a polygonal, in particular rectangular or hexagonal, shape. With respect to the circumferential direction, the support frame can be continuous or interrupted. If the support frame is interrupted, its individual parts can be attached one after the other to the corresponding regions of the flange for assembly.

It is also or alternatively conceivable that the holding element or at least one of the holding elements is or comprises at least one holding strip arranged on one side of the cooling device. Analogous to the embodiment in which the holding element is the holding frame, also according to this embodiment the holding strip is arranged or fastened to the outer region or to the or one of the lateral outer surfaces. The holding strip can form a portion of the holding frame, for example if the frame is interrupted. The holding strip can be designed to be straight and can extend in particular along a straight outer surface.

The holding element or at least one of the holding elements can have a T-shape when viewed in cross-section, wherein the longitudinal bar of the T-shape extends between the respectively adjacent battery cells and is connected to the cooling device, wherein the transverse bar of the T-shape rests laterally on the respectively adjacent battery cells. Thus, the longitudinal bar preferably extends along the large-area outer surfaces and the transverse bar along the lateral outer surfaces. The width of the longitudinal bar defines the distance between the two adjacent battery cells.

The cooling device can have a laterally projecting flange which is inserted into a groove of the longitudinal bar of the T-shape to connect the cooling device to the holding element. The groove and the flange inserted therein, in particular pushed in, preferably extend perpendicular to the T-shaped cross-section of the holding element. The flange extends by projecting laterally, in particular continuously or with interruptions, along an outer circumference of the cooling device. The flange can be fixed in the groove. For example, the flange can be clamped in the groove by having the flange slightly wider than the groove. Additionally or alternatively, the fastening can be realized by means of an adhesive connection.

It is conceivable that the cooling fluid guide portion is open towards the adjacent battery cell so that the cooling fluid guided therein comes into direct contact with this battery cell. According to this embodiment, the cooling fluid guide portion in which the cooling fluid is guided is delimited to the outside not only by components or portions of the cooling device, but also by the battery cell, in particular by an outer wall of the battery cell. This means that the cooling fluid and the battery cell come into direct contact with each other, which increases heat transfer. A further fluid-tight delimitation of the cooling fluid guide portion can be realized by means of the holding element, which can seal it laterally in a fluid-tight manner.

It is conceivable that the cooling fluid guide portion is sealed in a fluid-tight manner from the adjacent battery cell, in particular by means of at least one film. Thus, the heat transfer takes place via the film, which has sufficient thermal conductivity for the present purposes. The film can be made of a plastic and/or a metal, such as aluminum. The use of the film ensures the most reliable fluid tightness possible without the need for separate sealing means which are difficult to mount. It is conceivable to have several films that are attached to each other at the sides, for example. It is also conceivable to use a single, folded film, with portions of the film being attached to one another on the sides where the fold is not provided.

If the cooling fluid guide portion is sealed in a fluid-tight manner from the adjacent battery cell by means of the film or at least one of the films and the cooling device has the laterally protruding flange, then it is preferably provided that the flange is formed by the film or at least one of the films. In this embodiment, the film realizes several functions, namely the realization of the fluid tightness of the cooling fluid guide portion and the fastening of the cooling device with the respective holding element. It is preferably provided that the film or at least one of the films forms a receiving pocket for the cooling fluid guide portion, which is closed by means of a sealing seam and is arranged in the region of the flange. The sealing seam can be formed by welding or gluing.

It is preferably provided that at least one cooling fluid guide body is arranged in the cooling fluid guide portion or that the cooling fluid guide portion is formed from at least one cooling fluid guide body, wherein the at least one cooling fluid guide body consists of an open-pored material through which the cooling fluid can be guided. At least a large part of the pores of the material are connected to one another or communicate fluidically with one another, so that the cooling fluid flowing through the cooling fluid guide portion or the cooling fluid guide body flows through the pores accordingly. The open-pored material therefore has a sponge-like structure, with the pores forming cavities arranged between material webs and bridges, which provide the cooling fluid guide body with structural integrity or mechanical stability.

The open-pored material is preferably a metal foam, in particular an aluminum, copper, zinc, lead and/or iron foam. Metals have advantageous properties for the present purposes, in particular with regard to mechanical strength, elastic and plastic behavior and thermal conductivity. Aluminum in particular is advantageous due to its low density, which enables a lightweight construction of the energy storage device. In addition or as an alternative to the film, it is conceivable that the cooling fluid guide portion is sealed in a fluid-tight manner towards the adjacent battery cell via a closed side surface of the cooling fluid guide body. This can be produced by foaming the starting metal against a plate, creating a closed surface on this side.

According to the invention, it can be provided that in the region of the cooling fluid guide portion or at least one of the cooling fluid guide portions, at least one buffer element is arranged, which mechanically counteracts the reduction in the cross-section of the cooling fluid guide portion due to the expansion of the adjacent battery cell or the adjacent battery cells, in particular in addition to the cooling fluid guide body. The buffer element can be made of metal and/or plastic. The buffer element serves the purpose of counteracting excessive compression of the cooling fluid guide portion or the cooling fluid guide body, so that even in the event of strong swelling, the functionality of the cooling fluid guide portion, namely to guide a quantity of cooling fluid required to achieve a sufficient cooling effect, is maintained. Thus, in early phases or at the beginning of swelling, i.e. when the expansion of the battery cell is still small, an elastic effect that counteracts this expansion can be generated exclusively or mainly by means of the cooling fluid guide body. If this expansion exceeds a limit value, the expanding battery cell can come into sufficient active contact with the buffer element so that this elastic effect is additionally or alternatively caused by means of the at least one buffer element.

It is conceivable that several buffer elements are provided, each arranged locally at a location in the cooling fluid guide portion. Thus, counterforces, which are generated by the buffer elements, act locally and almost punctually on the battery cell. Therefore, the buffer elements can be described as almost point-like.

In addition or alternatively, it is conceivable that at least one buffer element extending flatly in the cooling fluid guide portion, which in particular is or comprises a grid, is provided. The buffer element can be or comprise a grid extending along a plane, wherein the grid also extends along a spatial direction perpendicular to this plane. A compression of the grid with respect to this spatial direction causes the counterforce. Consequently, the force generated by the buffer element acts on the battery cell over a large area.

In the energy storage device according to the invention, it can be provided that the cooling device has at least one supply element for supplying the cooling fluid into the cooling fluid guide portion and at least one discharge element for discharging the cooling fluid from the cooling fluid guide portion. The supply element and/or the discharge element can extend through the fluid-tight film and/or the fluid-tight closed side surface of the cooling fluid guide body and/or the holding element. Preferably, the supply element is a supply nozzle and/or the discharge element is a discharge nozzle. It is conceivable that the supply nozzle and the discharge nozzle or connection tabs on which the supply nozzle and the discharge nozzle are respectively arranged extend either in the same direction, in particular upwards or downwards, or in opposite directions, in particular laterally, away from the cooling fluid guide portion.

Furthermore, the present invention relates to a motor vehicle comprising an electric machine and an energy storage device connected to the electric machine according to the preceding description, wherein the electric machine is designed to generate a traction torque for the motor vehicle by means of electrical energy stored in the energy storage device. All advantages, features and aspects explained in connection with the energy storage device according to the invention are equally transferable to the motor vehicle according to the invention and vice versa.

It is conceivable that the traction torque is generated exclusively by means of the electric machine, so that the motor vehicle is a purely electric vehicle. It is also conceivable that the traction torque is additionally generated by means of an internal combustion engine, so that the motor vehicle is a hybrid vehicle.

The motor vehicle according to the invention can have a cooling system forming a cooling circuit and guiding the cooling fluid, into which the cooling fluid guiding portion is integrated. It is conceivable that at least one coolant pump for driving the circulation of the cooling fluid and optionally at least one cooling device, such as a condenser or a heat exchanger, by means of which heat can be dissipated from the cooling fluid, is integrated into the cooling circuit.

### BRIEF DESCRIPTION OF THE FIGURES

Further features, advantages and details of the present invention are obtained from the exemplary embodiments explained in the following and the figures. In particular, schematically:

FIG. 1 shows a schematic top view of a motor vehicle according to the invention according to an exemplary embodiment with an energy storage device according to the invention according to an exemplary embodiment,

FIG. 2 shows components of a cell stack of the energy storage device of the motor vehicle of FIG. 1 according to a first variant,

FIG. 3 shows a sectional view of an upper region of the cell stack of FIG. 2, the section line being indicated by III-III in FIG. 2,

FIG. 4 shows components of a cell stack of the energy storage device of the motor vehicle of FIG. 1 according to a second variant,

FIG. 5 shows a sectional view of an upper region of the cell stack of FIG. 4, the section line being indicated by V-V in FIG. 4,

FIG. 6 shows a sectional view of the cell stack of FIG. 2 before the occurrence of swelling, the section line being indicated by III-III in FIG. 2,

FIG. 7 shows the same sectional view of the cell stack of FIG. 2 as FIG. 6, after the occurrence or during the occurrence of swelling,

FIG. 8 shows an enlarged view of the region marked in FIG. 7 by means of the box VIII, wherein a cooling device of the energy storage device is provided according to a first alternative, and

FIG. 9 shows an enlarged view of the region marked in FIG. 7 by means of the box VIII, wherein a cooling device of the energy storage device is provided according to a second alternative.

### DETAILED DESCRIPTION

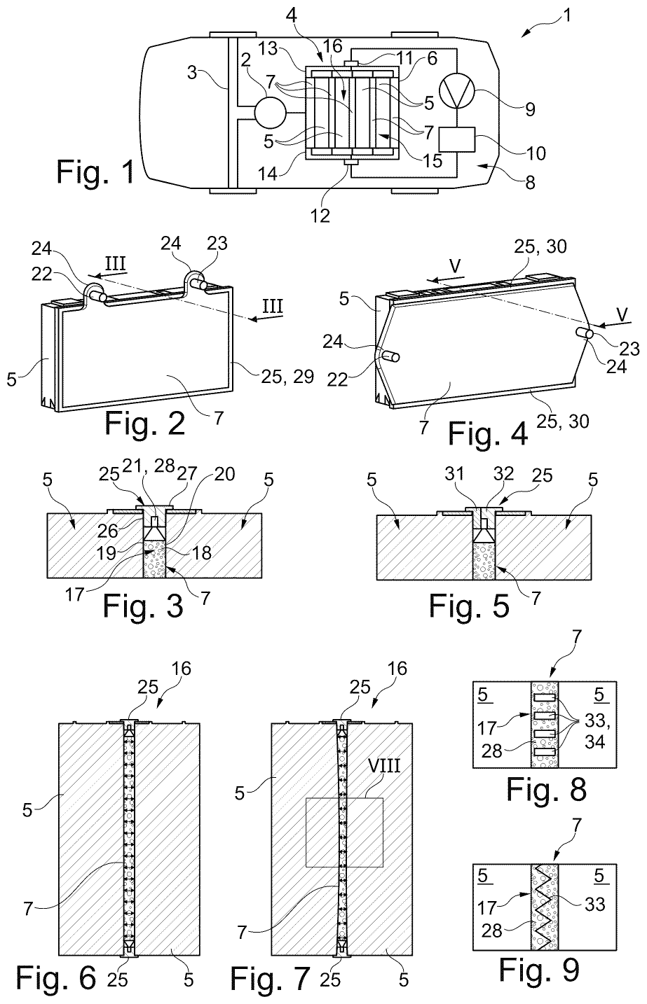

FIG. 1 shows a schematic plan view of a motor vehicle 1 according to the invention according to an exemplary embodiment, wherein the motor vehicle 1 is an electric vehicle and thus comprises an electric machine 2 provided for generating a traction torque. The traction torque can be transmitted from the electric machine 2 to the wheels of the motor vehicle 1 via a drive train 3. Optionally, the motor vehicle 1 additionally comprises an internal combustion engine for generating the traction torque.

In order to store electrical energy required to operate the electric machine 2, the motor vehicle 1 comprises a rechargeable energy storage device 4 according to the invention according to an exemplary embodiment. The energy storage device 4 comprises multiple battery cells 5. These are accommodated in an interior of a cuboid-shaped energy storage housing 6 made of a metal, in this case steel, wherein the interior forms a corresponding receiving space 15. To cool the energy storage device 4, the latter comprises multiple cooling devices 7. The battery cells 5 together with the cooling devices 7 form a cell stack 16 arranged in the receiving space 15 in a form-fitting manner, i.e. without play. Although only four battery cells 5 and five cooling devices 7 are indicated in FIG. 1, corresponding cell stacks 16 typically have a significantly higher number of these components 5, 7.

The energy storage device 4 or the cooling devices 7, each of which forms a cooling channel, are integrated into a cooling system 8 of the motor vehicle 1, which forms a cooling circuit and carries a cooling fluid. The cooling fluid circulating in the cooling system 8 is, for example, a water-glycol mixture. The cooling system 8 has a coolant pump 9, by means of which the cooling fluid can be conveyed, and a cooling device 10, which is for example a condenser and/or a heat exchanger and by means of which heat can be dissipated from the cooling fluid. The energy storage device 4 has a supply interface 12, via which the cooling fluid can be supplied to the energy storage device 4, and a discharge interface 11, via which the cooling fluid can be discharged from the energy storage device 4. A distribution unit 14 distributes the cooling fluid supplied via the supply interface 12 to the cooling chambers 7. A collection unit 13 brings the cooling fluid distributed to the cooling chambers 7 together to the discharge interface 11 after it has flowed through the cooling chambers 7.

The structure of the cell stack 16 according to a first variant is explained below with reference to FIG. 2. FIG. 2 shows only one of the battery cells 5 and one of the cooling devices 7, wherein the aspects explained therein basically apply equally to the remaining battery cells 5 and cooling devices 7. The battery cells 5 and the cooling devices 7 of this cell stack 16 are arranged alternately in series next to one another. Thus, one of the cooling devices 7 is arranged between each two adjacent battery cells 5 and between each of the two end battery cells 5 and a side wall of the energy storage housing 6.

The battery cells 5 and the cooling devices 7 are cuboid- and plate-shaped, wherein the two largest and thus large-area outer surfaces of the respective components 5, 7 are arranged directly adjacent to one another in order to realize the most effective possible heat transfer from the battery cell 5 to the cooling device 7. The cell stack 16 also has an overall cuboid structure which corresponds to the cuboid structure of the receiving space 15.

FIG. 3 shows a representation of a cross-section of the cell stack 16, wherein the section plane in FIG. 2 is indicated by the line III-III. The interior of the cooling device 7 forms a cooling fluid guide portion 17 within which the cooling fluid can be guided. In the cooling fluid guide portion 17, a cooling fluid guide body 18 is arranged, which consists of an open-pored and thus sponge-like material through which the cooling fluid flows. The pores communicate fluidically with each other so that the cooling fluid flows through the channel system formed by the pores of the cooling fluid guide body 18.

It is conceivable that the cooling fluid guide portion 17, i.e. in particular the cooling fluid guide body 18, is open towards the respective adjacent battery cell 5, so that the cooling fluid guided in the cooling fluid guide portion 17 comes into direct contact with this battery cell 5. In the present exemplary embodiment, however, it is provided, as is particularly evident from FIG. 3, that the cooling fluid guide portion 17 is sealed in a fluid-tight manner by means of a respective one of two films 19, 20 to the adjacent battery cells 5 or side wall of the energy storage housing 6. The films 19, 20 consist of a plastic and/or a metal. It is also conceivable in addition or alternatively that the cooling fluid body 18 has closed and thus fluid-tight side surfaces. In the present case, the films 19, 20 are sealed all around the edges by a sealing seam, for example by welding or gluing. The films 19, 20 thus form a closed bag or a closed receiving pocket, the interior of which forms the cooling fluid guide portion 17 having the cooling fluid guide body 18. The peripheral edges of the films 19, 20 form a laterally projecting flange 21 of the cooling device 7.

Referring again to FIG. 2, it can be seen that the cooling device 7 has a supply element 22 designed as a supply nozzle for supplying the cooling fluid into the cooling fluid guide portion 17 and a discharge element 23 designed as a discharge nozzle for discharging the cooling fluid from the cooling fluid guide portion 17. The elements 22, 23 are each arranged on a connection tab 24 which protrudes laterally from the region between the adjacent battery cells 5 and is formed by the films 19, 20. The elements 22, 23 penetrate or pass through the films 19, 20 into the interior of the receiving pocket. The connection tabs 24 extend in the same direction, namely upwards, for example. The supply element 22 and the supply interface 12 are connected to each other via the distribution unit 14. The discharge element 23 and the discharge interface 11 are connected to each other via the collecting unit 13.

For holding and fastening each of the cooling devices 7, a holding element 25 is provided, which is arranged in portions between two adjacent battery cells 5 together with the respective cooling device 7. By means of the holding element 25, the distance between the respective battery cells 5 is also defined and maintained. The holding element 25 is a holding frame 29 which laterally surrounds the cooling device 7 and is interrupted in the region of each of the connection tabs 24. In particular, it can be seen from FIG. 3 that the holding element 25, viewed in cross-section, has a one-piece T-shape, wherein a longitudinal bar 26 of the T-shape extends between the adjacent battery cells 5, wherein a transverse bar 27 of the T-shape rests on the lateral end faces of these battery cells 5. For fastening the holding element 25 to the battery cells 5, connections not shown in detail, such as screw connections, can be provided.

In order to hold the cooling device 7 by means of the holding element 25, the latter is connected to the longitudinal bar 26. For this purpose, the holding element 25 has a groove 28 extending perpendicular to the plane of the drawing in FIG. 3 and thus to the T-shaped cross-section, into which the flange 21, which also extends along this direction, is inserted, in particular clamped and/or glued. Because the sealing seam sealing the cooling fluid guide portion 17 is formed in the region of the flange 21, the fastening of the flange 21 in the groove 28 provides additional protection with regard to the fluid tightness of the cooling fluid guide portion 17. If the films 19, 20 are not provided, the holding element 25 can form a fluid-tight sealing of the cooling fluid guide portion 17.

A cell stack 16 according to a second variant is explained below with reference to FIGS. 4 and 5, which correspond to FIGS. 2 and 3. In principle, the aspects explained in connection with the first variant or with reference to FIGS. 2 and 3 apply equally to the second variant, apart from the differences explained below. One of the differences concerns the elements 22, 23 and the connection tabs 24. The connection tabs 24 according to the second variant extend laterally and in opposite directions away from the battery cells 5.

A further difference is that multiple holding elements 25 are provided, which according to the second variant are holding strips 30 arranged on one side of the cooling device 7, namely on the top and bottom. When viewed in cross-section, the holding elements 25 are each made up of multiple parts, namely, for example, two parts. For mounting or fastening the cooling device 7 to the holding element 25, the cooling device 7 is placed at a correspondingly provided position on a first component 31 of the holding strip 30. Subsequently, a second component 32 of the holding strip 30 is clipped to the first component 31, forming a clamping connection between the flange 21 and the groove 28. This multi-part concept is basically transferable to the first variant concerning the holding frame 29.

Reference is made below to FIG. 6, which shows a cross-sectional view of a part of the energy storage device 4, namely with respect to the same sectional plane as FIG. 3, wherein FIG. 6 shows the respective battery cells 5 and the cooling device 7 over the entire height. For reasons of clarity, the energy storage housing 6 is not shown in FIG. 6. While FIG. 6 shows the energy storage device 4 immediately after production, FIG. 7 shows the same energy storage device 4 in which the battery cells 5 have expanded laterally and a so-called “swelling” has taken place. Such expansions, in particular lateral bulges, can occur during charging of the energy storage device 4 or due to aging.

The expansion of the battery cells 5 causes a deformation or reduction in the size of the cooling fluid guide portions 17 and thus of the cooling fluid guide body 18. This results in a reduction in the cross-section of the cooling fluid guide portions 17 present in the region of expansion, at least in portions. The space available for the battery cells 5 is thus increased in this region, this increase being compensated by the reduction in size of the cooling fluid guide portions 17.

The described deformation of the cooling fluid guide portions 17 or the cooling fluid guide bodies 18 takes place plastically or elastically, so that the cooling fluid guide portions 17 only experience a change in their shape, but their structural integrity is maintained. This means that no material failure or breakage occurs in the region of the deformations, which in this case particularly concerns the cooling fluid guide bodies 18 and the films 19, 20. The cooling effect of the cooling fluid guide portions 17 affected by the cross-sectional reduction or tapering is maintained because, due to the coolant pump 9, the throughput or volume flow of the cooling fluid flowing through the cooling fluid guide portions 17 is kept at a sufficiently high level.

In the present case, the outer contour or shape of the energy storage housing 6 remains at least approximately the same despite the deformations caused by the swelling. This is achieved by the fact that the energy storage housing 6 has a higher mechanical strength than the cooling devices 7, in particular than the cooling fluid guide bodies 18. This difference in mechanical strength results from the fact that different materials are used, namely steel for the energy storage housing 6 and aluminum foam for the cooling fluid guide bodies 18.

A further aspect of the present embodiment is explained below with reference to FIGS. 8 and 9. FIG. 8 shows a first alternative and FIG. 9 a second alternative with respect to the cooling device 7, wherein all aspects explained so far are basically applicable to both alternatives. FIGS. 8 and 9 each show an enlarged view of the region marked in FIG. 7 by the dashed box VIII.

In both alternatives, it is provided that at least one buffer element 33 is arranged in the cooling fluid guide portion 17. This mechanically counteracts the reduction in the cross-section of the cooling fluid guide portion 17 due to the expansion of the adjacent battery cells 5. When swelling occurs or as soon as the expansion of the battery cells 5 exceeds a certain limit, the buffer element 33 is compressed, which as a corresponding reaction generates a counterforce, in particular an elastic one, which prevents the cross-section of the cooling fluid guide portion 17 from being completely closed.

According to the first alternative, the buffer elements 33 arranged in the cooling fluid guide body 18 are each arranged locally at a specific location in the cooling fluid guide portion 17 and consist of a plastic material. The buffer elements 33 are approximately point-shaped with respect to the large outer surfaces. In this embodiment, the force generated by each of the buffer elements 33 acts on the battery cell 5 almost punctually.

According to the second alternative, the buffer element 33 arranged in the cooling fluid guide body 18 is a grid 34 made of a metal that extends in a plane in the cooling fluid guide portion 17. The grid 34 extends along a plane that is vertical and perpendicular to the plane of the drawing, with reference to FIG. 8, and thus flatly within the gap between the battery cells 5 in which the cooling device 7 is arranged. Furthermore, the grid also has an extension with respect to the spatial direction perpendicular to this plane, wherein the compression of the buffer element 33 causing the counterforce affects this plane. According to this embodiment, the force generated by the buffer element 33 acts on the battery cell 5 over a large area.

With regard to both alternatives, it is provided that when swelling occurs, the battery cells 5 only come into contact with the buffer element 33 or the buffer elements 33 when the cross-section of the respective cooling fluid guide portion 17 falls below a limit value. Thus, in the state shown in FIG. 6, there is still a distance between the buffer element 33 or the buffer elements 33 and the respective battery cells 5. In an early phase of the swelling, i.e. when the expansion of the battery cells 5 is still small, only an elastic effect of the cooling fluid guide body 18 generates a counterforce counteracting the corresponding expansion. Later, namely when swelling is advanced, the counterforce is generated both by means of the cooling fluid guide body 18 and by means of the buffer element 33.

1. An energy storage device for a motor vehicle, comprising an energy storage housing and at least one battery cell accommodated therein, wherein at least one cooling device is arranged adjacent to the battery cell or to at least one of the battery cells in such a way that this battery cell can be cooled by a cooling fluid guided in at least one cooling fluid guide portion of the cooling device,
wherein at least one portion of the cooling device is plastically or elastically deformable, so that an expansion of the adjacent battery cell or of the adjacent battery cells due to the charging cycle and/or aging causes a deformation of the cooling device in such a way that the cross-section of the cooling fluid guide portion is reduced at least in portions.

2. The energy storage device according to claim 1, wherein the battery cell or at least one of the battery cells and the cooling device or at least one of the cooling devices are plate-shaped.

3. The energy storage device according to claim 1, wherein multiple battery cells are provided, wherein the cooling device or at least one of the cooling devices is arranged between at least two of the battery cells, wherein the plate-shaped battery cells form a cell stack.

4. The energy storage device according to claim 3, wherein at least one holding element is arranged at least in portions between the battery cells between which the cooling device is arranged, wherein the holding element or at least one of the holding elements defines the distance between the respective battery cells and holds the cooling device.

5. The energy storage device according to claim 4, wherein the holding element or at least one of the holding elements is a holding frame laterally surrounding the cooling device, which is continuous or has interruptions, and/or comprises at least one holding strip arranged on one side of the cooling device.

6. The energy storage device according to claim 4, wherein the holding element or at least one of the holding elements has a T-shape when viewed in cross-section, wherein the longitudinal bar of the T-shape extends between the respectively adjacent battery cells and is connected to the cooling device, wherein the transverse bar of the T-shape rests laterally on the respectively adjacent battery cells.

7. The energy storage device according to claim 6, wherein the cooling device has a laterally projecting flange which is inserted into a groove of the longitudinal bar of the T-shape to connect the cooling device to the holding element.

8. The energy storage device according claim 1, wherein the cooling fluid guide portion is open towards the adjacent battery cell so that the cooling fluid guided therein comes into direct contact with this battery cell, and/or in that the cooling fluid guide portion is sealed in a fluid-tight manner towards the adjacent battery cell by at least one film.

9. The energy storage device according to claim 8, wherein the cooling fluid guide portion is sealed in a fluid-tight manner from the adjacent battery cell by the film or at least one of the films, wherein the flange is formed by the film or at least one of the films.

10. The energy storage device according to claim 9, wherein the film or at least one of the films forms a receiving pocket for the cooling fluid guide portion closed by a sealing seam, wherein the sealing seam is arranged in the region of the flange.

11. The energy storage device according to claim 1, wherein at least one cooling fluid guide body is arranged in the cooling fluid guide portion or the cooling fluid guide portion is formed from at least one cooling fluid guide body, wherein the at least one cooling fluid guide body consists of an open-pored material through which the cooling fluid can be guided.

12. The energy storage device according to claim 1, wherein in the region of the cooling fluid guide portion or at least one of the cooling fluid guide portions at least one buffer element, made of a metal and/or a plastic, is arranged, which mechanically counteracts the reduction in the cross-section of the cooling fluid guide portion due to the expansion of the adjacent battery cell or the adjacent battery cells.

13. The energy storage device according to claim 12, wherein multiple buffer elements are provided, each arranged locally at a location in the cooling fluid guide portion, and/or at least one buffer element extending flatly in the cooling fluid guide portion, which is a grid, is provided.

14. The energy storage device according to claim 1, wherein the cooling device has at least one supply element for supplying the cooling fluid into the cooling fluid guide portion and at least one discharge element for discharging the cooling fluid from the cooling fluid guide portion, wherein the supply element is a supply nozzle and/or the discharge element is a discharge nozzle.

15. A motor vehicle, comprising an electric machine and an energy storage device connected to the electric machine according to claim 1, wherein the electric machine is designed to generate a traction torque for the motor vehicle by electrical energy stored in the energy storage device.

16. The energy storage device according to claim 2, wherein multiple battery cells are provided, wherein the cooling device or at least one of the cooling devices is arranged between at least two of the battery cells, wherein the plate-shaped battery cells form a cell stack.

17. The energy storage device according to claim 5, wherein the holding element or at least one of the holding elements has a T-shape when viewed in cross-section, wherein the longitudinal bar of the T-shape extends between the respectively adjacent battery cells and is connected to the cooling device, wherein the transverse bar of the T-shape rests laterally on the respectively adjacent battery cells.

18. The energy storage device according claim 2, wherein the cooling fluid guide portion is open towards the adjacent battery cell so that the cooling fluid guided therein comes into direct contact with this battery cell, and/or in that the cooling fluid guide portion is sealed in a fluid-tight manner towards the adjacent battery cell by at least one film.

19. The energy storage device according claim 3, wherein the cooling fluid guide portion is open towards the adjacent battery cell so that the cooling fluid guided therein comes into direct contact with this battery cell, and/or in that the cooling fluid guide portion is sealed in a fluid-tight manner towards the adjacent battery cell by at least one film.

20. The energy storage device according claim 4, wherein the cooling fluid guide portion is open towards the adjacent battery cell so that the cooling fluid guided therein comes into direct contact with this battery cell, and/or in that the cooling fluid guide portion is sealed in a fluid-tight manner towards the adjacent battery cell by at least one film.
